(19) United States
(12) Patent Application Publication
(10) Pub. No.: US 2011/0206574 A1
(43) Pub. Date: Aug. 25, 2011

(54) METHOD AND SYSTEM FOR MECHANICAL LIQUID-FUEL RECLAMATION AND REFORMATION

(76) Inventor: Joseph L. Donnelly, Auburn, WA (US)

(21) Appl. No.: 13/028,528

(22) Filed: Feb. 16, 2011

Related U.S. Application Data
(60) Provisional application No. 61/306,883, filed on Feb. 22, 2010.

(51) Int. Cl. B01J 19/18

(52) U.S. Cl. 422/225

(57) ABSTRACT

Various embodiments of the present invention employ a mechanical rotor-based device that subjects a liquid fuel to fluid-shear forces and cavitation in order to reclaim the fuel by removing impurities and by additional fuel-reformation processing. In certain embodiments of the present invention, rotor-based device can be mounted within a vehicle or other mobile device to provide or facilitate on-board fuel reclamation and reformation. Other embodiments include larger-scale, stationary rotor-based devices for fuel reclamation and reformation in plants, depots, manufacturing and transportation facilities, and in other energy-consuming facilities.

### CROSS-REFERENCE TO RELATED APPLICATION

This application claims the benefit of Provisional Application No. 61/306,883, filed Feb. 22, 2010.

### TECHNICAL FIELD

The present invention relates to the field of liquid-fuel reclamation, including cleaning, removing impurities from, and processing the fuel.

### BACKGROUND OF THE INVENTION

Fuel reformers are used to reform fuel into reformate gasses, including hydrogen and carbon monoxide. Reformate gasses may be used for a variety of purposes, including combustion, oxidation in fuel cells, and synthesis of various different organic feedstock chemicals. Current reformation processes utilize large amounts of steam and produce enormous amounts of carbon monoxide and carbon dioxide, both directly by reformation process and indirectly, as a result of secondary processes that provide the energy required for the reformation process. Current reformation processes may consume relatively large amounts of energy, may involve use of expensive catalysts, and may generate many undesirable side products. Those involved in liquid-fuel reformation continue to seek new reformation processes that consume less input energy, involve fewer or no expensive catalysts, and that produce fewer or no unwanted side products.

### SUMMARY OF THE INVENTION

Various embodiments of the present invention employ a mechanical rotor-based device that subjects a liquid fuel to fluid-shear forces and cavitation in order to reclaim and reform the fuel by removing impurities and by additional fuel processing. In certain embodiments of the present invention, rotor-based device can be mounted within a vehicle or other mobile device to provide or facilitate on-board fuel reclamation and reformation. Other embodiments include larger-scale, stationary rotor-based devices for fuel reclamation and reformation in plants, depots, manufacturing and transportation facilities, and in other energy-consuming facilities.

### BRIEF DESCRIPTION OF THE DRAWINGS

FIG. 1 illustrates reclamation, reformation, and electricity-generations processes.

FIG. 2 illustrates an on-board fuel reclamation and reformation system that represents one embodiment of the present invention.

FIG. 3 shows an external view of the reclamation and reformation unit that represents one embodiment of the invention.

FIG. 4 shows a rotor chamber within a reclamation and reformation unit that represents one embodiment of the current invention.

FIG. 5 shows a rotor-housing end cap of one embodiment of the present invention.

FIGS. 6A-B show two views of a fuel-reclamation-unit rotor according to one embodiment of the current invention.

FIG. 7 shows an exploded diagram of a reclamation and reformation unit that represents one embodiment of the current invention from two different perspectives.

FIGS. 8A-8D show tables of parameters that need to be considered at the design and operational stages of on-board fuel reclamation according to certain embodiments of the current invention.

### DETAILED DESCRIPTION OF THE INVENTION

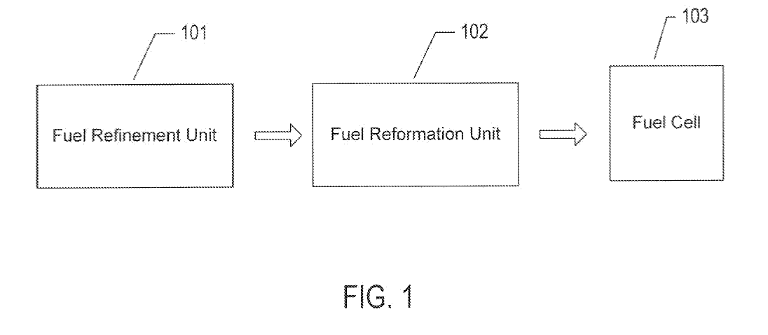

Certain embodiments of the present invention are directed to on-board reclamation of fuel within a motorized vehicle, at the point in time and in the location where a final, finishing reclamation can most effectively prepare the fuel for use with a fuel cell. FIG. 1 illustrates reclamation, reformation, and electricity-generations processes. A reclamation and refining process 101 cleans, reclaims, and refines the fuel, including removing contaminates, such as sulfur-containing and nitrogen-containing contaminates, from the fuel to prevent poisoning the fuel cell. A reformation process 102 converts the hydrocarbon fuel into hydrogen gas and carbon-containing byproducts. Electricity generation 103 occurs in a fuel cell, where hydrogen is oxidized to water.

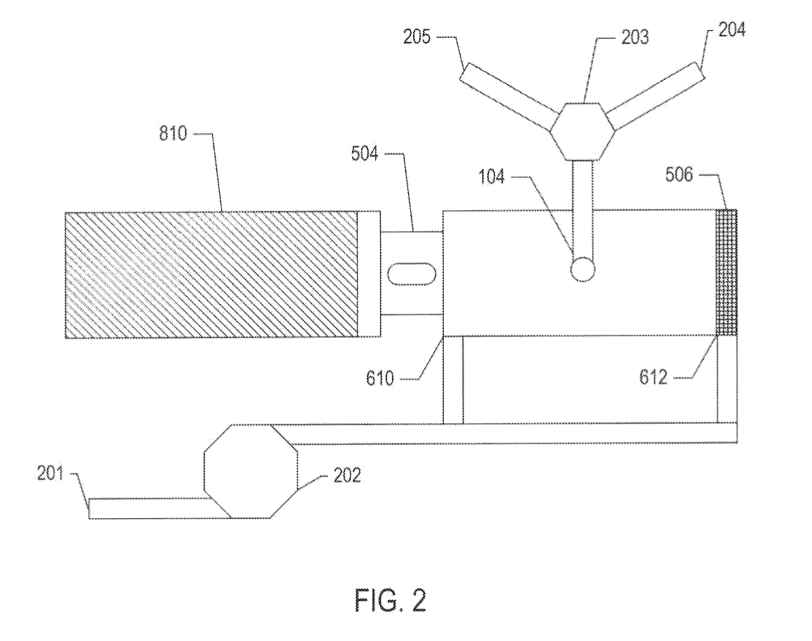

FIG. 2 illustrates an on-board fuel reclamation and reformation system that represents one embodiment of the present invention. Fuel is introduced from the fuel source 201 through a high pressure fuel pump 202 and inlet ports 610 and 612 into a reclamation and reformation unit 504. The fuel is accelerated under pressure in the reclamation and reformation unit 504 while a rotor 604 spins at a specific speed determined, in part, by a gap between the rotor 604 and the housing 504, a pattern of depressions on the rotor 604, and the viscosity and compressibility of the fuel. The fuel is expelled through the exhaust port 104 when it reaches a sufficient pressure to overcome the cracking pressure of the exhaust port 104. This pressure is set to allow for enough pressure to build up for the fuel to be reclaimed and reformed by the combined forces of centrifugal acceleration, cavitation, mechanical sheer, and friction. The combined gasses, fluids and solids are then separated in a filter/separator 203, from which hydrogen is sent to the fuel cell/collector 204 and the remaining fluids are used to purge and clean the system and sent through a filtration system 205, in one embodiment of the present invention, to a reservoir.

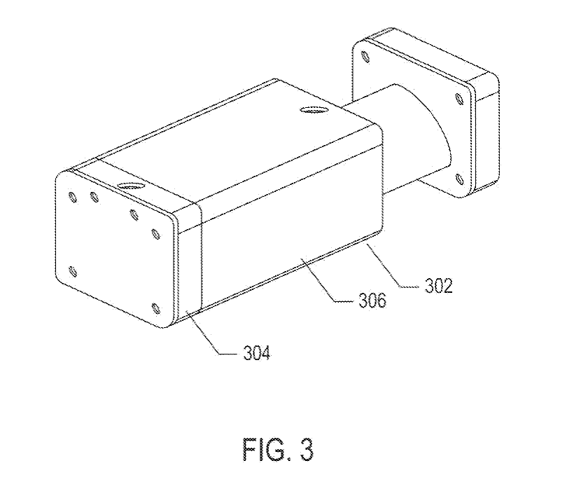

FIG. 3 shows an external view of the reclamation and reformation unit that represents one embodiment of the invention. The reclamation and reformation unit 302 includes a rotor-and-rotor-chamber housing 304, a rotor-housing end cap 306, and a motor mount 308 that mounts the reclamation and reformation unit to a motor that spins a rotor within the reclamation and reformation unit in order to apply fluid shear forces to the fuel within the reclamation and reformation unit and generate cavitation within the fuel.

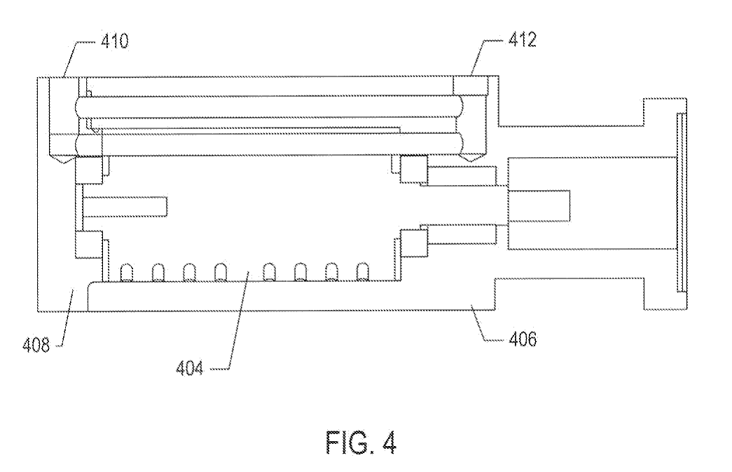

FIG. 4 shows a rotor chamber within a reclamation and reformation unit that represents one embodiment of the current invention. The rotor chamber 404 is an empty, enclosed and sealed, roughly cylindrical volume formed by the rotor-and-rotor-chamber housing 406 and rotor-housing end cap 408. Two inlet ports 410 and 412 provide channels through which fuel is input, under pressure generated by the fuel-refining-unit pump (202 in FIG. 2), into the rotor chamber.

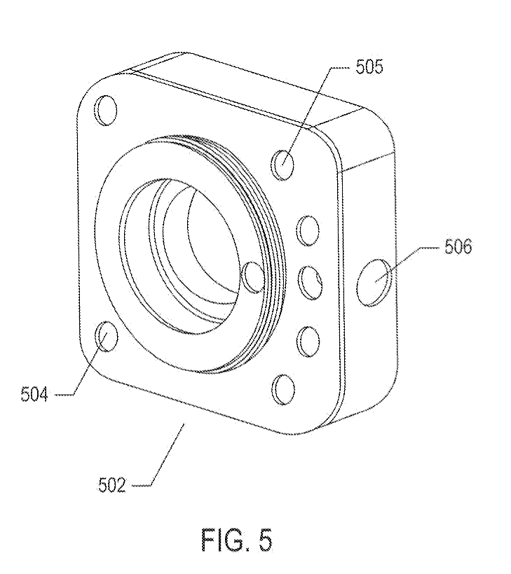

FIG. 5 shows a rotor-housing end cap of one embodiment of the current invention. The rotor-housing end cap 502 includes apertures for attachment bolts, including apertures 504-505, and the inlet port 506.

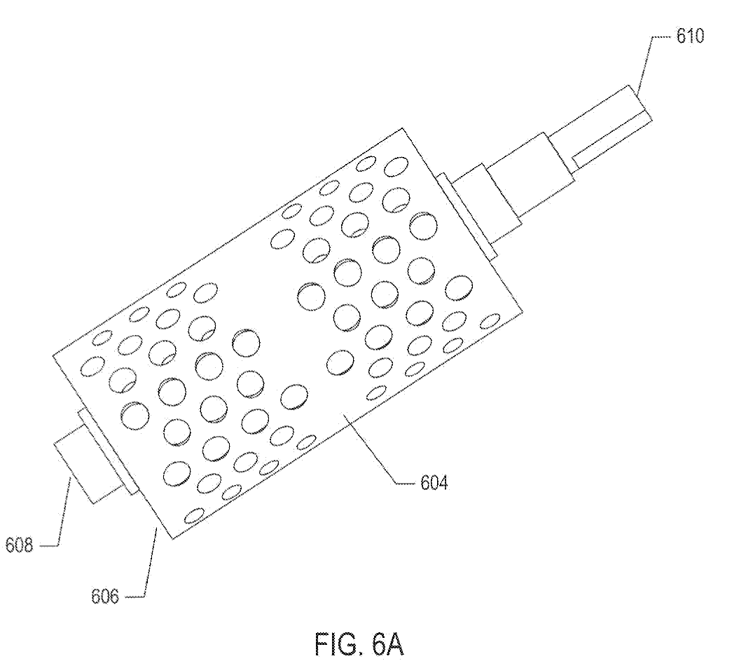

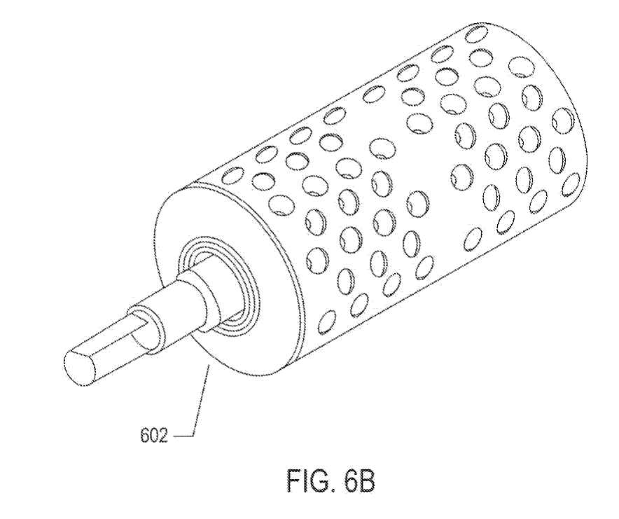

FIGS. 6A-6B show two views of a reclamation and reformation unit according to one embodiment of the current invention. The rotor 602 includes a cylindrical fuel-processing surface, into which a number of radially-oriented depressions are machined, such as depression 606. The rotor includes a rotor shaft, on end of which 608 is rotatably mounted in a complementary cylindrical mounting feature of the rotor-housing endplate, and the other end 610 of which is mounted through a coupling to the rotating shaft of a motor. The depressions, including depression 806, are arranged into a pattern on the cylindrical fuel-processing surface, with the pattern, diameter of the depressions, depth of the depressions, and shape of the depressions all potentially significant parameters with respect to the operational characteristics of the reclamation and reformation unit.

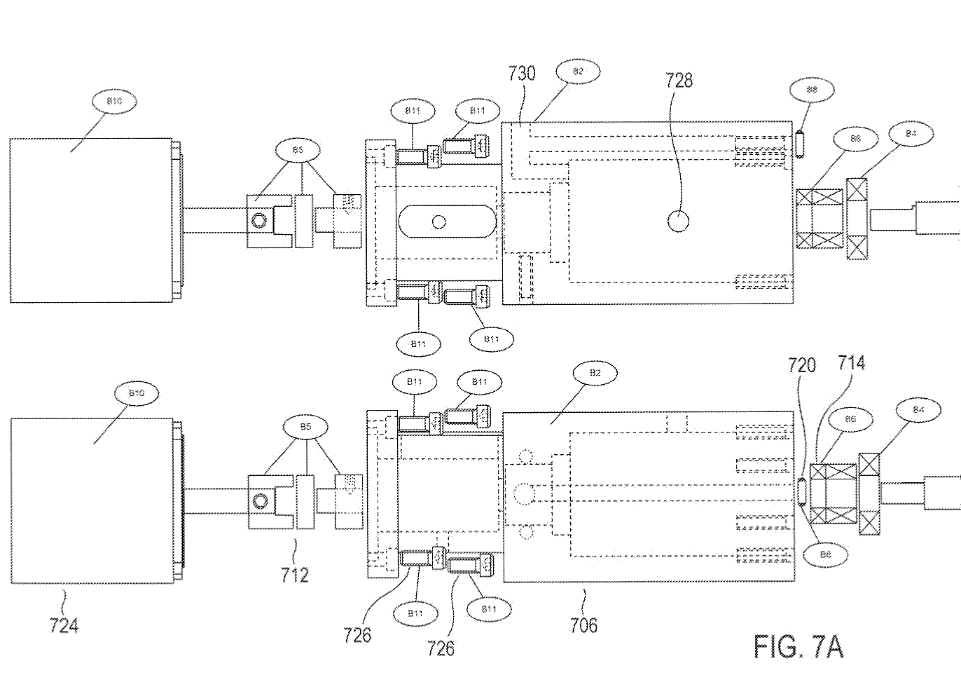

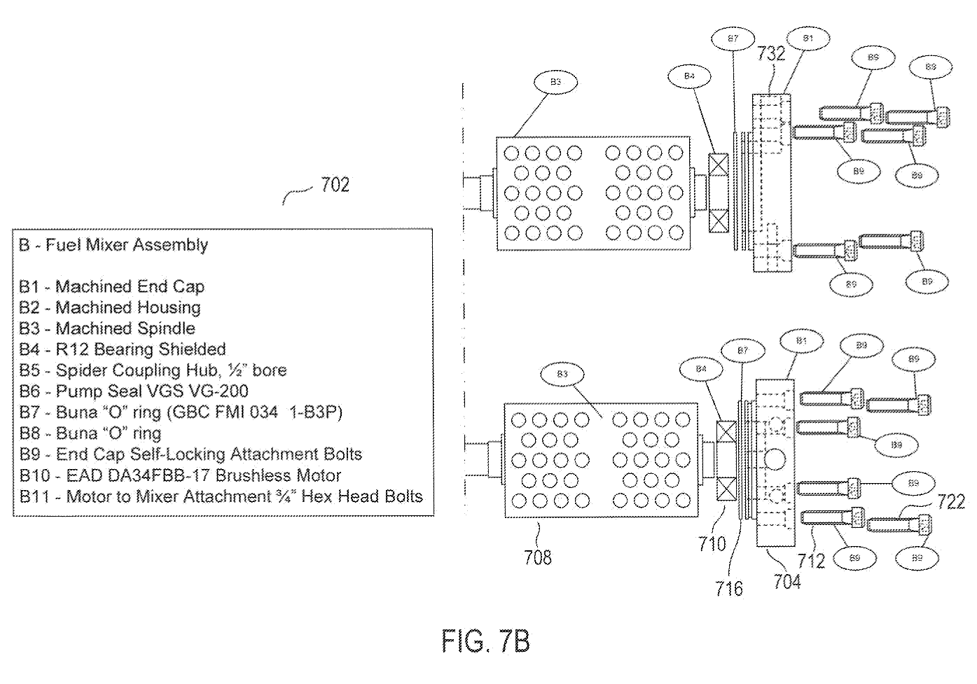

FIG. 7 shows an exploded diagram of a reclamation and reformation unit that represents one embodiment of the current invention from two different perspectives. The figure is shown with alphanumeric labels defined in a figure key 702. Numerical labels are additionally provided, and referred to in the following text. The exploded diagram of the fuel-refining unit shows many of the parts of the fuel-refining unit. These parts include: (1) a rotor-housing end cap 704; (2) a machined rotor-and-rotor-chamber housing 706; (3) a rotor 708; (4) a shielded bearing 710; (5) a spider coupling 712; (6) a pump seal 714; (7) a large-diameter “O” ring 716; (8) a small diameter “O” ring 720; (9) attachment bolts 722 that attach the rotor-housing end plate to the rotor-and-rotor-chamber housing; (10) an electric motor 724; (11) attachment bolts 726 that attach the motor-mount portion of rotor-housing end plate to the motor housing; (12) and exhaust port 728 from which fuel leaves the rotor chamber and is carried to gas liquid filter (203 in FIGS. 2); and (13) inlet ports 730 and 732 through which fuel is introduced into the rotor chamber.

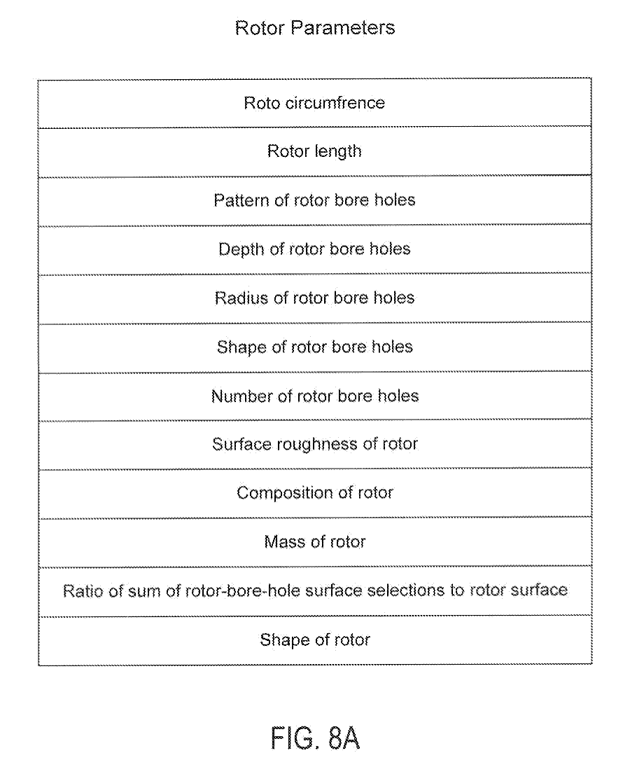

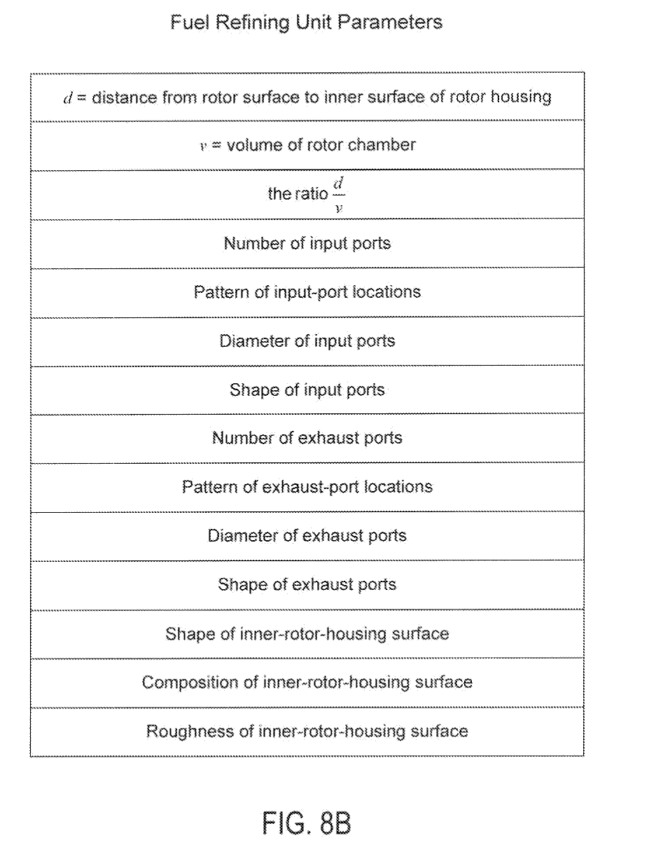

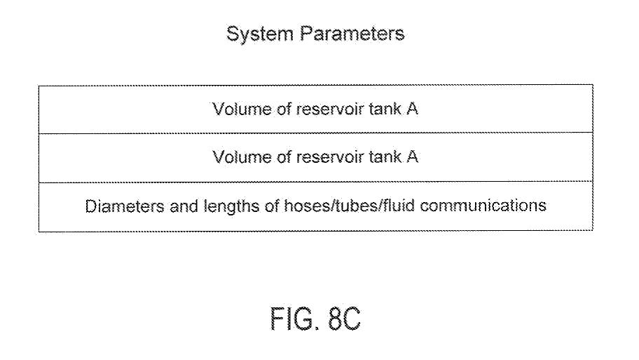

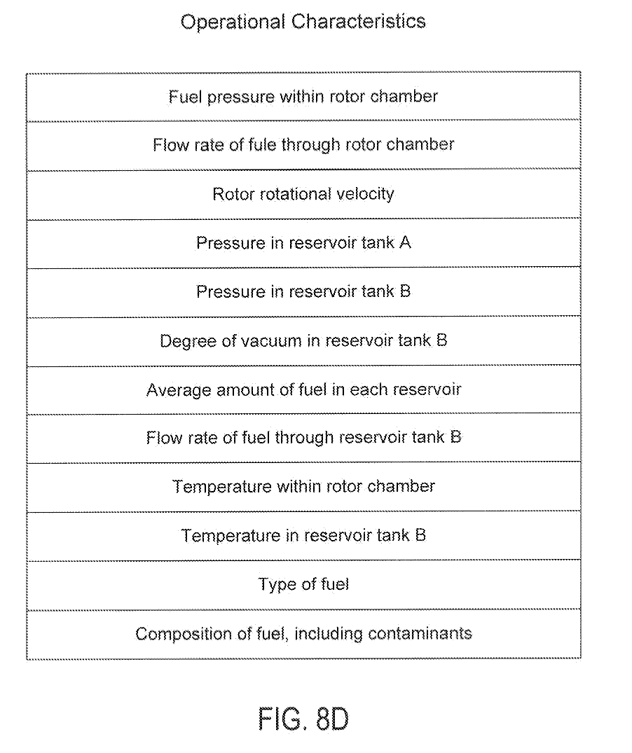

FIGS. 8A-8D show tables of parameters that need to be considered at the design and operational stages of on-board fuel reformation according to certain embodiments of the current invention. FIGS. 8A-8C provide tables that show various design parameters that affect characteristics of the refined fuel output from the fuel-reformation unit. FIG. 8D provides a table that shows various on-board-fuel-reformation-system operational parameters that affect characteristics of the reformation fuel output from the fuel-reformation.

The table shown in FIG. 8A includes various rotor parameters, values for which are selected during design and trials of an on-board fuel-refining system. These rotor parameters include: (1) rotor circumference (or diameter, or radius); (2) rotor length; (3) pattern of rotor depressions; (4) depth of rotor depressions; (5) radii of rotor depressions; (6) shape of rotor depressions; (7) number of rotor depressions; (8) surface roughness of rotor; (9) composition of rotor; (10) mass of rotor; (11) percentage of ideal, cylindrical surface of rotor represented by depressions; and (12) rotor shape. In general, the depression-bearing surface of the rotor is cylindrical, but slight variations in the shape, including elliptical shapes and various patterns of longitudinal variations in radius are possible. The rotor surface and rotor depressions, spinning at high rates of revolution, induces fluid shear forces within the fuel in the rotor chamber, and may additional create cavitation. Cavitation produces extremely high, but short-duration temperatures that can induce a variety of chemical and physical changes of the fuel. Shear forces can also cause chemical changes, and the combined effects of pressurization and rotor forces may influence the types and quantities of dissolved gasses in the fuel, in addition to changing the chemical composition of the fuel. The above-listed parameters may all, separately or in various combinations, influence the fluid shear forces and amount of cavitation to which the fuel is subjected, as well as the amount of time that the fuel resides in the rotor chamber, average temperatures in the rotor chamber, and local temperatures produced by cavitation.

The table shown in FIG. 8B includes various reclamation-and-reformation unit parameters, values for which are selected during design and trials of an on-board fuel-reformation system. These rotor parameters include: (1) distance from the rotor surface to the inner surface of the rotor-and-rotor-chamber housing, d; (2) volume of the rotor-and-rotor-chamber housing, v; (3) the ratio d/v; (4) the number of inlet ports; (5) the spatial arrangement of inlet ports; (6) the diameter of inlet ports; (7) the shape of the inlet ports; (8) the number of exhaust ports; (9) the spatial arrangement of exhaust ports; (10) the diameter of exhaust ports; (11) the shape of the exhaust ports; (12) the shape of the inner-rotor-and-rotor-chamber housing; (13) composition of the rotor-and-rotor-chamber housing; and (14) roughness of the inner surface of the rotor-and-rotor-chamber housing. In general, the above-listed parameters principally affect the time to which fuel is exposed to reclamation and reformation conditions within the rotor chamber, temperature and pressure within the rotor chamber, and pressure of various gasses dissolved in, and in equilibrium with, the refined fuel. Fuel reclamation and reformation induces fluid shear forces within the fuel in the rotor chamber, and may additional create cavitation. The above-listed parameters may all, separately or in various combinations, influence the conditions to which the fuel is subjected in the rotor chamber, and therefore may affect the characteristics and parameters of the output, refined fuel.

The table shown in FIG. 8C includes various reclamation-and-reformation system parameters, values for which are selected during design and trials of a reclamation and reformation system. These reclamation-and-reformation system parameters include: (1) volume of reservoir tank A; (2) volume of reservoir tank B; and (3) the diameters, lengths, and other characteristics of fluid connections between various stages and components of the on-board-fuel-reformation-system. In general, the above-listed parameters principally affect the time to which fuel is exposed to reformation conditions within the rotor chamber, temperature and pressure within the rotor chamber, and pressure of various gasses dissolved in, and in equilibrium with, the refined fuel.

The table shown in FIG. 8D includes various operational parameters of the reclamation and reformation system, values for which are continuously adjusted during motor-vehicle operation. These operational parameters include: (1) fuel pressure within the rotor chamber; (2) rate of flow of fuel through the rotor chamber; (3) rotational velocity of the rotor; (4) pressures in reservoir tank A and B; (5) degree of vacuum in reservoir tank B; (6) average amount of fuel in each of reservoir tanks A and B, as well as thresholds for each reservoir tank that determine when corresponding pumps are activated or shut off; (7) rate of flow of fuel through reservoir tank B; (8) temperature within the rotor chamber; (9) the temperature in reservoir tank B; (10) the type of fuel; and (11) composition of fuel, including nature and amounts of contaminants. In general, the above-listed parameters principally affect the time to which fuel is exposed to reclamation and reformation conditions within the rotor chamber, temperature and pressure within the rotor chamber, and pressure of various gasses dissolved in, and in equilibrium with, the refined fuel. All of these parameters may, alone or in various combinations, affect the composition and characteristics of the output, reformed fuel.

Although the present invention has been described in terms of a particular embodiment, it is not intended that the invention be limited to this embodiment. Modifications within the spirit of the invention will be apparent to those skilled in the art. For example, other types of mechanical, chemical, electrical, and other processes may be used in addition to, or instead of, the rotor-based fluid-shear and cavitation induction used in the disclosed embodiment. Such techniques may change the temperature, pressure, and other parameters of the fuel, and may apply various forces or conditions that allow activation barriers for specific chemical reactions to be overcome. Many different types of optimization techniques and parameter-monitoring and parameter-adjustment techniques may be used to tailor on-board fuel reformation to the specific and current conditions of the hydrocarbon to hydrogen reformation. The various design and operational parameters, discussed above, have different optimal values for each different type of fuel reformation, internal converting liquid hydrocarbon fuels to clean hydrogen for fuel cells. The design and operational parameters are not necessarily independent from one another. In one embodiment of the present invention, the distance d is 0.1 inch, the rotor diameter is 2.4 inches, there are two fuel-inlet ports and one fuel-exhaust port, each inlet port and the exhaust port a ¼ inch NPT with a ⅜ inch JIC fitting, fuel pressure in the rotor chamber between 3 and 6 psi, flow rate through the rotor chamber of between 16 and 22 gph, and speed of the rotor revolution at 2735±50 rpm. In addition, it has been found optimal to switch between flow rates of 17 gph and 21 gallons per hour. In this embodiment, greater than 12% improvement in fuel efficiency was observed, with significant (4.5% to 18%) drops in the mentioned pollutant gasses. However, much greater fuel-efficiency increases have been observed under certain conditions of operation. The various parameters and characteristics are likely to vary depending not only on vehicle and engine type, but also on current environmental and driving conditions.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1. A fuel-reclamation unit comprising:
a rotor that rotates within a rotor housing into which liquid fuel is introduced through one or more input ports and from which reclaimed fuel is extracted through one or more output ports;
an electric motor that provides rotational force to the rotor to spin the rotor within the housing to generate shear forces and cavitation within the liquid fuel;
an input-fuel introduction means selected from one of a fuel line and a fuel reservoir; and
and a reclaimed-fuel output means selected from one of a fuel line and a fuel reservoir.

2. A fuel-reformation unit comprising:
a rotor that rotates within a rotor housing into which liquid fuel is introduced through one or more input ports and from which reformed fuel is extracted through one or more output ports;
an electric motor that provides rotational force to the rotor to spin the rotor within the housing to generate shear forces and cavitation within the liquid fuel;
an input-fuel introduction means selected from one of a fuel line and a fuel reservoir; and
and a reclaimed-fuel output means selected from one of a fuel line and a fuel reservoir.
